(19) United States
(12) Patent Application Publication
(10) Pub. No.: US 2009/0151848 A1
(43) Pub. Date: Jun. 18, 2009

(54) Method for bonding components made of high silica material

(75) Inventors: Waltraud Werdecker, Hanau (DE); Juergen Weber, Kleinostheim (DE); Norbert Traeger, Maintal (DE); Maximilian Kara, Erlenbach (DE); Roland Horn, Neuendettelsau (DE)

Correspondence Address: TIAJOLOFF & KELLY, CHRYSLER BUILDING, 37TH FLOOR, 405 LEXINGTON AVENUE, NEW YORK, NY, 10174, US

(73) Assignee: Heraeus Quarzglas GmbH & Co. KG, Hanau (DE)

(21) Appl. No.: 12/316,496

(22) Filed: Dec. 12, 2008

(30) Foreign Application Priority Data
Dec. 14, 2007 (DE) DE102007060980.0

(51) Int. Cl. B32B 37/02

(52) U.S. Cl. 156/62.2

(57) ABSTRACT

The present invention relates to a method for bonding components made of high silica material by way of integral joining by forming a high-silica bonding mass between connecting surfaces of the components. A method is provided which permits an inexpensive production of a mechanically and thermally stable composite of components made of a high silica material, particularly for large-area bonded connections for which a contact pressure of more than 5 N/cm² is applied while the connecting surfaces are being fixed, and/or the path length for possible degassing products from the bonded connection is more than 150 mm. This object is achieved according to the invention in that the SiO₂ bonding mass is used in dry form either right from the beginning or at least the SiO₂ bonding mass is dried on the connecting surfaces before the joining process and the surfaces to be bonded are subsequently brought into contact and a firm composite is created by way of heating with formation of a SiO₂ containing bonding mass.

The present invention relates to a method for bonding components made of high silica material by way of integral joining by forming a high-silica bonding mass between the connecting surfaces of the components.

Herein, the term “high silica material” is understood to be doped or undoped quartz glass with a SiO₂ content of at least 85%. This material shall hereinafter also be called “quartz glass” for short. Quartz glass is characterized by a low coefficient of thermal expansion, by optical transparence over a wide wavelength range and by high chemical and thermal resistance.

Quartz glass components are used for many applications, e.g. in lamp manufacture as cladding tubes, bulbs, cover plates or reflector carriers for lamps and radiators in the ultraviolet, infrared and visible spectral range, in chemical apparatus construction or in semiconductor manufacture in the form of reactors and apparatus made of quartz glass for the treatment of semiconductor components, jigs, bell jars, crucibles, protective shields or simple quartz glass components, such as tubes, rods, plates, flanges, rings or blocks.

For producing special properties quartz glass is doped with other substances, such as titanium, aluminum, boron or germanium.

Frequently, there is a need to connect quartz glass elements to one another, e.g. for the manufacture of quartz glass components having a complex shape. As a rule, this joining operation is performed by welding the components together. EP 1 042 241 A1, for instance, describes a method for butt welding quartz glass tubes. The welding process includes a melting of the surfaces to be joined and pressing the softened surfaces against each other, which may easily lead to an undesired plastic deformation in the area of the welding zone. Although such deformations can be eliminated by complicated finishing work, dimensional deviations usually remain.

For producing precision parts composed of several quartz glass parts, joining techniques have also been suggested that include bonding methods using organic adhesive materials, which however withstand low temperatures only.

Joining methods employing glass solders, as are for example also described in DD 289 513 A5, are also known. The use of a glass solder based on lead-zinc borate is suggested for the dimensionally stable and vacuum-tight joining of precision parts made of quartz glass. An acetone-soluble paste is formed from a powder of the glass solder with particles sizes between 1 μm and 70 μm, and said paste is applied to a connecting surface. The parts (tube and plate) to be connected are fixed relative to each other and the connecting surfaces are pressed against each other. This composite is introduced into a soldering furnace and subjected to a temperature treatment with a maximum temperature of 450° C. and for a period of time of 3.5 hours. The glass solder melts in this process and is converted into a crystalline phase of an increased melting temperature at the same time. The integral bonded connection established in this way is distinguished by a low vacuum leakage rate up to a temperature of 500° C. Nevertheless, this bonded connection cannot satisfy the particularly high demands made on temperature stability and thermal shock resistance as required in many thermotechnical applications of quartz glass. Moreover, the known bonded connection does also not meet the demands made on purity and freedom from contamination, as found e.g. in applications in semiconductor manufacture, in optics, but also in the field of chemistry, medicine, research and analytical technology.

Furthermore, DE 10 2004 054 392 A1 discloses a generic method for bonding components made of high silica material, wherein a pourable or paste-like slurry, which contains amorphous SiO₂ particles, is applied to one or both connecting surfaces, which are subsequently immediately fixed relative to or onto each other. The bonding mass, which is more or less enclosed between the two connecting surfaces, is then dried. In one example according to this prior art two plates are interconnected in this way, wherein the SiO₂-containing slurry is applied by a spraying process to the bottom side of the upper quartz glass plate and the upper side of the lower quartz glass plate, respectively. The upper plate is then placed immediately on the lower plate. With correspondingly slow drying a crack-free dried layer is obtained that is suited for bonding these two plates of a relatively small size. This method is no longer suited for large-area connections at a correspondingly high pressing pressure already due to the dead weight of the quartz glass parts to be bonded, or it would require long and uneconomic drying periods for removing the dispersant of the bonding mass from the joining place without any defects.

It is therefore the object of the present invention to provide a method which permits an inexpensive production of a mechanically and thermally stable composite of components made of a high silica material, particularly for large-area bonded connections for which a contact pressure of more than 5 N/cm² is applied while the connecting surfaces are being fixed, and/or the maximum path length for possible degassing products from the bonded connection is more than 150 mm.

Starting from the above-mentioned method this object is achieved according to the invention in that the SiO₂ bonding mass is used in dry form either right from the beginning or at least the SiO₂ bonding mass is dried on the connecting surfaces before the joining process and the surfaces to be bonded are subsequently brought into contact and a firm composite is created by way of heating with formation of a SiO₂ containing bonding mass.

In the method according to the invention the connection of the components is based on a SiO₂-containing bonding mass which must be dried before the connecting surfaces are brought into contact with each other, or is present in dried form already from the start. An aqueous SiO₂ slurry that contains amorphous SiO₂ particles can be used as the bonding mass. The pourable or pasty slurry is applied to one or to both connecting surfaces. First the connecting surfaces remain separated from each other. A drying phase is now carried out which is characterized by expelling the dispersant, e.g. water, from the connection layer; shrinkage must here be expected to a certain extent. The challenge is that the mass will not crack due to this shrinkage, but that a homogeneous crack-free bonding mass will be formed. Since the connecting surfaces with the bonding mass are exposed to the drying process without any pressure load by the component area to be joined, there is no problem with regard to the removal of possible degassing products during drying. This is conducive to the homogeneity of the bonding mass. A further important factor is that in the event that a slurry is started from, said slurry contains amorphous SiO₂ particles. These particles are subject to interactions which already stabilize the slurry mass in its pasty and dry state and promote the sintering activity, which facilitates the solidification of the dried slurry mass at comparatively low temperatures with formation of a dense crack-free SiO₂-containing bonding mass. To ensure an economic overall process with a short drying time for the large-area bonding of quartz glass parts, the drying process is performed with an open surface of the bonding parts to be joined. The dispersant of the slurry can thereby be expelled from the applied layer of the bonding mass within a very short period of time. An alternative possibility regarding large-area joining connections of quartz glass parts with a high silica bonding mass is that the bonding mass is not applied in a pourable or pasty form, but already in a dry or pre-dried form, e.g. in the form of a powder layer of amorphous SiO₂ particles which are applied to and optionally pressed against the connecting surfaces. Moreover, a green foil which has been produced from a SiO₂ slurry and pre-dried before can be applied or specifically laminated as bonding mass to the surfaces of the quartz glass components to be joined.

For solidifying and compacting the dried bonding mass on the quartz glass components to be bonded, these are brought into contact with one another and then heated to a temperature leading to a sintering or melting of the amorphous SiO₂ particles with formation of a crack-free SiO₂-containing bonding mass consisting of opaque, partly opaque and partly transparent or completely transparent high silica glass.

During sintering or vitrification of the dry bonding mass, crystallization should be avoided or at least minimized in the SiO₂-containing bonding mass, which would lead to a weakening of the bonded connection. In this context it is also important that the SiO₂ particles used for forming the bonding mass are amorphous. They consist of synthetically produced SiO₂ or they are produced on the basis of purified naturally occurring raw material.

Furthermore, attention must be paid that a stable SiO₂-containing bonding mass is produced that ensures a stable and reliable connection between the large-area components even upon temperature changes. In this regard, special attention is paid to the thermal expansion coefficient of the SiO₂-containing bonding mass and its temperature dependence as compared to the thermal expansion coefficient or coefficients of the components to be connected.

In this regard, the use of a SiO₂-containing bonding mass that is “generic” with regard to the high silica material plays an important role. Herein this shall mean that the SiO₂ content of the bonding mass differs from that of the high silica components to be connected by not more than 3% by wt. The use of “generic material” for the formation of the bonding mass allows, on the one hand, a maximal approximation of the thermal expansion coefficients between the quartz glass of the components and the bonding mass, and associated with this, particularly good adhesion of the solidified SiO₂-containing bonding mass to the connecting surfaces and, on the other hand, a high thermal shock resistance of this composite. Furthermore, contamination of the quartz glass of the components to be connected or their operative environment by foreign substance present in the generic material is thus prevented.

Roughness and unevenness of the connecting surfaces do not necessarily have a disadvantageous effect in the method according to the invention. On the contrary, this surface roughness can even improve the adhesion of the dry SiO₂-containing bonding mass.

To sum up, it should be noted that since in the bonding method according to the invention the quartz glass components to be connected are brought into contact with each other only after the bonding compound has been dried, the method is suited for large-area connections in the case of which a contact pressure is more than 5 N/cm² during fixation of the connecting surfaces and/or the maximum path length for possible degassing products from the bonded connection is more than 150 mm. Moreover, the drying periods are short, so that the method is inexpensive.

Advantageous developments of the method are found in the sub-claims.

In a first variant of the method, a bonding mass is exposed in the form of an aqueous SiO₂ slurry which contains amorphous SiO₂ particles with mean particle sizes of less than 5 μm, preferably less than 1 μm.

Amorphous SiO₂ particles in this order of magnitude and with such a size distribution show an advantageous sintering behavior and comparatively low shrinkage during drying. Due to the above-explained interaction, which may even lead to the formation of molecular SiO₂ compounds, the fine nanoparticles show an action similar to that of a binding agent and promote the sintering and vitrifying behavior. It has been found that with such a bonding mass a high basic density of the bonding layer is generated, which layer can be dried and solidified without the formation of cracks.

Preferably, the SiO₂ content of the amorphous SiO₂ particles is at least 99.9% by wt.

The solids content of a SiO₂ slurry prepared by using such particles consists of at least 99.9% by wt. of SiO₂. Binding agents or similar additives are not provided. In this regard, this is a generic starting material for a component assembly made of non-doped quartz glass. This starting material does not entail any risk of contamination or crystallization.

Advantageously, the solids content of the slurry during preparation of a slurry mass on the connecting surfaces is at least 65% by wt., preferably at least 80% by wt., particularly preferably at least 83% by wt. This high solids content reduces shrinkage during drying and solidification, and thereby reduces the formation of strains in the SiO₂-containing bonding mass and, in addition, improves the dimensional stability and dimensional accuracy of the composite.

For the application of the slurry, the per se known procedures are suited, such as spraying, electrostatically-supported spraying, flooding, centrifugation, laying on (painting), or troweling. Application techniques suited for the uniform covering of large areas are, in particular, immersion or spraying or also screen printing. The lamination of a green foil of quartz glass is also a possible application technique within the meaning of the invention.

Apart from amorphous dense SiO₂ particles, the bonding mass may also contain other amorphous SiO₂ starting material.

For example, it has proven favorable for at least part of the amorphous SiO₂ particles to be provided in the form of porous granulate particles made of agglomerates of nano-scale, amorphous, synthetically produced SiO₂ primary particles with a mean primary particle size of less than 100 nm.

Primary particles of this type are obtained by flame hydrolysis or oxidation of silicon compounds. Upon granulation the agglomeration of the fine-particulate SiO₂ primary particles leads to the formation of coarser granulate particles. As a result, compaction and solidification that promote the subsequent sintering and vitrifying processes are already started in the bonding mass, compaction and solidification being based on a certain degree of solubility and mobility of individual primary particles in the bonding mass, which contributes to so-called “neck formation” between adjacent amorphous SiO₂ particles in the bonding mass. During drying of the SiO₂-enriched bonding mass with a liquid phase in the area of the “necks”, these necks solidify and establish a firm connection between the individual amorphous SiO₂ particles, and lead to compaction and solidification of the bonding mass, which simplifies subsequent sintering. The porosity of the granulate as well as the associated large specific surface result in a high sintering activity.

A further preferred embodiment of the bonding mass is formed by a dry powder. A dry quartz glass grain or/and a quartz glass granulate are used as the bonding mass.

Nano-scale SiO₂ powders show good flow characteristics, so that the uniform application to a planar area of a quartz glass component is definitely guaranteed. The preferred mean particle sizes for these quartz glass granules or quartz glass granulates used in a dry state as bonding masses are within the range of 10 μm and 40 μm.

It is then possible to apply the quartz glass component to be joined while omitting a drying period. This variant should particularly be preferred when a very large area composite with a relatively thick joining mass is needed and the removal of possible dispersants from the bonding mass requires too much time or is uneconomic for other reasons.

Moreover, it can be advantageous that the bonding mass comprises an additional intermediate layer which is applied by spreading quartz glass grain or/and quartz glass granulate onto a bonding mass which is already provided on the connecting surfaces and contains a dispersant. As a rule, such a first bonding mass is used with dispersant in the form of a screen-printable paste because uniform, thin and large-area layers can be applied with the screen printing technique at low costs and in a reproducible manner. It is also possible to reverse the sequence, i.e. first to apply a SiO₂ powder to the joining area and then to apply a SiO₂ bonding mass containing a dispersant. The dispersant must be removed during drying before the parts to be joined get into contact. In this process the powder layer applied subsequently (or previously) can increase the filling degree of the bonding mass and shorten the drying time on the whole.

In a preferred variant of the method, solidification of the bonding mass comprises sintering with formation of an at least partly opaque bonding mass.

In comparison with vitrification up to complete transparence, sintering requires comparatively low sintering temperatures and/or short sintering times. This helps to observe the dimensional accuracy of the component assembly to be manufactured, reduces the amount of energy needed, and avoids thermal impairment of the components to be connected, as well as crystallization in the area of the bonding mass.

It has been found that for most applications an adequate mechanical strength of the SiO₂-containing bonding mass can already be accomplished by sintering (and not only by complete vitrification).

The degree of compaction depends on the sintering temperature and sintering duration. The higher the temperature, the shorter is the sintering period, and vice versa. A standard and preferred temperature treatment for sintering the slurry mass comprises heating at a temperature within the range between 800° C. and 1450° C., preferably at a temperature below 1300° C.

In the simplest case sintering is carried out in a sintering furnace into which the components to be connected are introduced. The uniform heating of the whole component assembly in a sintering furnace reduces the formation of strains and avoids deformations of the composite. In a further preferred variant of the method, solidification of the bonding mass includes vitrification with formation of an at least partly transparent, solidified SiO₂-containing bonding mass.

A complete vitrification of the SiO₂-containing bonding mass is preferred, if particularly high demands are made on tightness, strength, absence of particles and similar stability of the composite, if optical transparence is needed in this area technically or for purely esthetic reasons. In this case the SiO₂-containing bonding mass contains no or few pores and shows a high density, which corresponds approximately to that of the silica components.

As a rule, however, vitrification of near-surface areas of the SiO₂-containing bonding mass is sufficient. If these vitrified areas interconnect the connecting surfaces, they help to increase the mechanical strength and also the tightness of the composite even if otherwise the SiO₂-containing bonding mass contains pores and is opaque.

Vitrification is preferably carried out using a heating source the maximum heating action of which can be locally limited to the bonding mass.

The action of the high temperatures needed for vitrification can here be limited locally to the bonding mass to be vitrified and plastic deformations are thereby avoided or reduced. For this purpose burners or infrared lasers (e.g. SiO₂ lasers) are used.

In the case of a preceding sintering step the residual heat is advantageously used and the still hot component assembly is vitrified. This helps to save energy and the formation of strains is prevented.

In a further preferred variant of the method for solving the above-mentioned problem with respect to the thermal expansion coefficient of the SiO₂-containing bonding mass, a mass is used that contains one or more of the following dopants: Al₂O₃, TiO₂, Y₂O₃, AlN, Si₃N₄, ZrO₂, BN, HfO₂, Si, Yb₂O₃, and/or SiC. By adding one or more of the said dopants the thermal expansion coefficient of the SiO₂-containing bonding mass can be matched to that or those of the components to be joined. Preferably, doping with a dopant is carried out such that the formation of a crystalline phase in the SiO₂-containing bonding mass is avoided.

The present invention shall now be explained in more detail with reference to embodiments and a drawing.

The drawing schematically shows in detail in

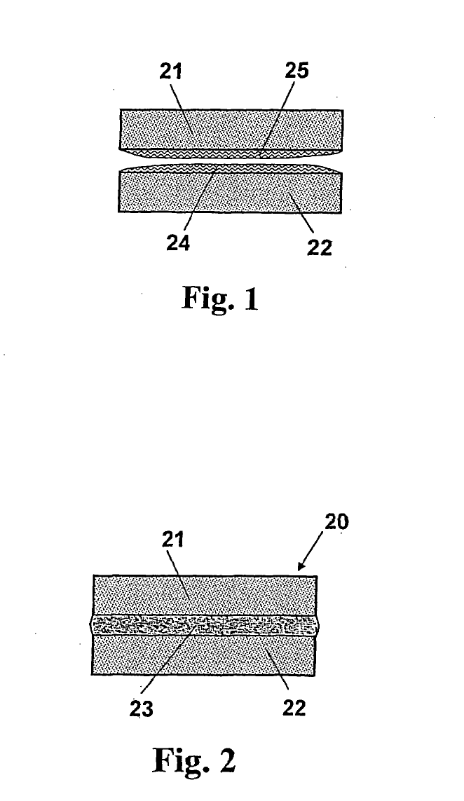

FIG. 1: the joining of two quartz glass plates according to the method of the invention;

FIG. 2: the resulting component assembly according to the method step of FIG. 1.

To prepare the adhesive bond according to FIGS. 1 and 2, a homogeneous stabilized base slurry is first prepared. To prepare a batch of 10 kg of base slurry, 1.8 kg of deionized water with a conductivity of less than 3 μS is mixed with 8.2 kg of an amorphous quartz-glass granulate made of natural raw material with grain sizes in the range between 250 μm and 650 μm and an SiO₂ content of 99.99%, in a quartz glass-lined drum mill with a volume of approximately 20 liters.

This mixture is then comminuted by means of grinding beads of quartz glass on a roller bracket at 23 rpm for a period of three days until a homogeneous stabilized base slurry with a solids content of 82% is obtained. During comminution the dissolving SiO₂ reduces the pH to a value of approximately 4.

The amorphous SiO₂ particles in the base slurry obtained after wet comminution of the quartz glass granulate have a particle size distribution that is characterized by a D₅₀ value of about 5 μm and by a D₉₀ value of about 23 μm.

Further amorphous SiO₂ granulate with a mean grain size of about 5 μm is added to the homogeneous base slurry obtained in this way until the solids content is 90% by wt. The mixture is then homogenized in a drum mill at 25 rpm for 12 hours. The slurry thus obtained has a solids content of 90% by wt. and a density of almost 2.0 g/cm³.

The base slurry is used in this state for the manufacture of the adhesive connection according to the invention, as shall be described in more detail in the following.

FIG. 2 schematically shows a composite body 20 consisting of a lower quartz glass plate 22 and an upper quartz glass plate 21 which are interconnected by means of an opaque SiO₂-containing intermediate layer 23 of a thickness of 1 mm. Each of the plates has a thickness of 3 mm and is square with an edge length of 250 mm. It follows from these dimensions, on condition that the plates 21 and 22 have each a specific weight of 2.2 g/cm³, that due to the dead weight of the upper plate 21 of 412.50 g a contact pressure of 6.6 N/cm² acts on the lower plate 22 with the bonding masses 24 and 25 and the intermediate layer 23, respectively. If in this case the connecting surfaces were placed on each other directly after application of the slurry this would not result in a uniform drying of the bonding mass 23, 24. The degassing products from the middle of the square plates 21, 22 would have to cover a path length up to the plate rim of between 125 mm and 176 mm, which does not promise a flawless degassing process.

The opaque intermediate layer 23 serves for example as a transmission barrier for heat radiation. Quartz glass components, such as flanges, in high temperature applications are often made completely or partly of opaque quartz glass to block heat radiation. For the purpose of cleaning, the components usually are etched with hydrofluoric acid-containing chemicals. Opaque quartz glass, however, has a low etching resistance such that the service life of such opaque quartz glass components ends after relatively few cleaning cycles. For this reason, transparent quartz glass is melted onto the opaque surface areas of the components. This is a hot process which tends to cause deformation of the component in such a way that a costly after-treatment will be needed.

The composite body 20 according to the invention, as shown schematically in FIG. 2, represents such an opaque component covered by transparent quartz glass on both sides. It is suited to replace components of this type which have been costly to produce until now, whereby the transparent layers 21, 22 can easily be applied also in thick layers.

In order to prepare the composite body 20, the plates 21, 22 are first degreased and cleaned. Subsequently, the above-described slurry is applied to the upper side of the lower quartz glass plate 22 and to the lower side of the upper quartz glass plate 21 in the form of a slurry layer 24, 25, each having a thickness of approximately 1.5 millimeter, the slurry layer acting as the bonding mass. The application process can be carried out by way of spraying. Other application techniques, however, such as screen printing, spreading by doctor blade, laying on (painting), troweling, etc., are also possible alternatives. It is important that a uniform coverage of the surfaces to be connected is achieved. This is schematically shown in FIG. 1.

The component areas provided with the bonding mass are first air-dried for one hour. Complete drying is performed using an IR radiator in air. The dried bonding mass 24, 25 consisting of the slurry layer is without cracks, and it has a maximum thickness of about 2.5 mm.

It is only after the layer has dried completely that the composite body 20 is produced by bringing the two plates 21 and 22 into contact with each other and is sintered in a sintering furnace in air atmosphere. Due to pre-drying the bonding mass does not contain a degassable substance any more, so that sintering is carried out without any risk in this respect.

The heating profile during sintering comprises a heating ramp in which the dried bonding mass is heated from room temperature within one hour to a heating temperature of 1250° C. The composite body 20 is held at this heating temperature for two hours. An intermediate layer 23 which firmly connects the two quartz glass plates 11, 22, which is sintered, but still opaque, and which with regard to the quartz glass plate 21 and 22 is made of generic material and has a mean specific density of about 2.10 g/cm³ is formed from the bonding mass. The composite body 20 manufactured in this way is slowly cooled down in the sintering furnace, a first cooling ramp being 5° C. per minute and showing a furnace temperature of 1050° C. The second cooling ramp is 10° C. per minute and ends at a furnace temperature of 950° C. Further cooling is carried out thereafter irregularly and in a closed state of the furnace. Due to the relatively slow cooling process the component assembly is annealed, so that existing mechanical strains are reduced and the formation of strains due to cooling is avoided.

The plate-shaped composite body 20 prepared in this way is opaque and about 8 mm thick. It consists of three layers 21, 22 and 23, of which the middle layer 23 is approximately 2 mm thick and accounts for the opacity and is covered on both sides by layers 21, 22 having a thickness of 3 mm and made of dense, transparent quartz glass characterized by a high etching resistance. In addition, the composite body 20 is thermally stable, characterized by high thermal shock resistance at operating temperatures above 100° C.

The method described above is also well-suited for the manufacture of a composite body that consists completely of transparent quartz glass. For this purpose it is only necessary to completely vitrify the intermediate layer 23 rather than to sinter it. For this purpose, the composite body is vitrified in a vitrification furnace after drying of the bonding mass. The heating profile during vitrification comprises a heating ramp during which the bonding mass is heated in the form of the slurry layer from room temperature to a heating temperature of 1350° C. within two hours. The composite body is kept at this heating temperature for two hours. The slurry layer thus gives rise to a sintered intermediate layer of generic material, which firmly connects two quartz glass plates and has a mean specific density of about 2.2 g/cm³. In this fashion, it is not only possible to increase the thickness of quartz glass plates, but also to build-up quartz glass blocks.

An alternative joining technique within the meaning of the present invention is that a slurry is not applied as bonding mass to the quartz glass components to be connected, but a dry granular quartz glass layer. This granulate is spread as uniformly as possible on a planar joining surface, e.g. with the help of a doctor blade. Monomodal spherical quartz glass grains with a D₅₀ value between 5 μm and 40 μm are particularly well suited. However, granulates which are built-up of nanoscale SiO₂ powders can also be used for this purpose. Since the loose granulation contains no fixing agents as bonding mass for the composite component, only the lower quartz glass plate 22 is covered with the powder layer, the thickness of this bonding mass ranging from 0.5 mm to several millimeters, depending on the total geometry to be accomplished with the component assembly. It is particularly advantageous in this embodiment that a drying step can be omitted altogether and that the upper quartz glass plate 21 can be immediately placed on the lower plate after the application of powder to said lower plate. Depending on the grain spectrum used for the bonding mass 23 as granulation layer, the “plate sandwich” is sintered at a sintering temperature between 1200° C. and 1450° C. in a sintering furnace. In the present example the plates 21 and 22 are made of transparent quartz glass and are circular with a diameter of 300 mm and a thickness of 2.5 mm each. Due to the dead weight of the upper plate 21 of about 388.80 g the upper plate exerts a contact pressure of 5.5 N/cm² on the lower plate 22 with the spread-on granulation as bonding mass. If in this instance a bonding mass with evaporating dispersant was used and if the connecting surfaces were immediately placed on each other after application of said mass, no uniform drying of the bonding mass 24 could be achieved. The degassing products from the center of the circular plates 21, 22 would have to cover a distance up to the plate edge of 150 mm, which does not promise a flawless degassing process.

A SiO₂ powder layer is applied as the bonding mass 24 to the upper side of the plate 22, the granulation layer being uniformly distributed over the plate surface by gentle vibration. The quartz glass granulation Excelica® SE 15 of the company Tokuyama Ltd. is used as the powder, said granulation comprising spherical SiO₂ particles with a mean particle size of 15 μm. The sintering program for this composite has a heating-up rate of 2.5° C./minute from about room temperature to 1400° C. The holding time at 1400° C. is three hours. In this case, and despite the relatively high sintering temperature, no transparent intermediate layer is produced because with the loose quartz glass granulation the particle distance is nevertheless too large for achieving a pore-free dense sintering process. The plate-shaped composite body 20 produced in this way with an opaque intermediate layer 23 is slowly cooled down in the sintering furnace, with a first cooling ramp being 5° C. per minute and showing a furnace temperature of 1050° C. The second cooling ramp is 10° C. per minute and ends at a furnace temperature of 950° C. Further cooling is then performed irregularly in the closed state of the furnace. Due to the relatively slow cooling process the component assembly is annealed such that existing mechanical strains are reduced and the formation of strains caused by cooling is avoided. These circular plates with opaque intermediate layer 23 are e.g. used as reflector plates in the semiconductor industry, namely in hot areas which additionally require a pore-free surface.

A further embodiment according to the invention is made up of a combination of the above-explained variants for the manufacture of a composite body 20. In this instance, a very thin layer of SiO₂ base slurry is first applied, as has been described above, to the upper side of the lower plate 21 and to the lower side of the upper plate 22. The layer is applied by means of screen printing and has a layer thickness in the range of about 30 μm to 100 μm. A dry quartz glass granulation is spread onto the still moist screen printing layer, whereby the individual particles are fixed by the still moist SiO₂ layer applied by means of screen printing. The above-mentioned SiO₂ powder Excelica® SE 15 can be used as quartz glass granulation or also a combination of several grain fractions of similar powder qualities, e.g. also Excelica® SE 30, which has a mean particle size of 30 μm. Subsequently, the plates 21 and 22 prepared in this way with the bonding mass 23, 24 are dried; the drying period can here be kept short because in fact hardly any dispersant has to be removed from the screen printing layer. The drying period is not more than about 30 minutes and is carried out in a drying cabinet in air at about 120° C.

Subsequently, the plates are placed on one another, the sides of the plates getting into contact with the bonding mass and being finally sintered with a sintering program, as has been described above. As a result of this variant of the method, one obtains a composite body 20 which comprises an opaque intermediate layer 23 and is preferably used as a reflector component in the semiconductor industry in hot processes.

1. A method for bonding components made of high silica material, said method comprising: a joining process including forming a high-silica bonding mass between connecting surfaces of the components, wherein the high-silica bonding mass is in dry form when introduced between the connecting surfaces or the bonding mass is dried on the connecting surfaces before the joining process and the surfaces to be bonded are subsequently brought into contact and a firm composite is created by heating so as to form a SiO₂ containing bonding mass.

2. The method according to claim 1, wherein an aqueous SiO₂ slurry which contains amorphous SiO₂ particles with mean particle sizes in the range of less than 5 μm is used for the high-silica bonding mass.

3. The method according to claim 2, wherein the bonding mass has an SiO₂ content of the amorphous SiO₂ particles in the high-silica bonding mass that is at least 99.9% by wt.

4. The method according to claim 2, wherein the slurry for the high-silica bonding mass between the connecting surfaces has a solids content that is at least 65% by wt.

5. The method according to claim 1, wherein a dry quartz glass grain or/and a quartz glass granulate is used as the high-silica bonding mass.

6. The method according to claim 5, wherein the quartz glass grain and/or the quartz glass granulate has a mean particle size between 10 μm and 40 μm.

7. The method according to claim 1, wherein the high-silica bonding mass comprises an additional intermediate layer that is applied by spreading quartz glass grain or/and quartz glass granulate over a first bonding mass already positioned on the connecting surfaces.

8. The method according to claim 1, wherein the method further comprises a sintering process that comprises a temperature treatment of the dry high-silica bonding mass at a temperature between 800° C. and 1450° C.

9. The method according to claim 8, wherein the method further comprises solidifying the high-silica bonding mass by said sintering of the dry high-silica bonding mass so as to form an at least partly opaque solidified bonding mass.

10. The method according to claim 1, wherein the high-silica bonding mass contains one or more dopants selected from the group consisting of Al₂O₃, TiO₂, Y₂O₃, AlN, Si₃N₄, ZrO₂, BN, HfO₂, Si, Yb₂O₃, and/or SiC.

11. The method according to claim 1, wherein an aqueous SiO₂ slurry which contains amorphous SiO₂ particles with mean particle sizes in the range of less than 1 μm is used for the high-silica bonding mass.

12. The method according to claim 2, wherein the slurry for the high-silica bonding mass between the connecting surfaces has a solids content that is at least 80% by wt.

13. The method according to claim 2, wherein the slurry for the high-silica bonding mass between the connecting surfaces has a solids content that is at least 83% by wt.
